(19) United States
(12) Patent Application Publication
(10) Pub. No.: US 2024/0322284 A1
(43) Pub. Date: Sep. 26, 2024

(54) CONTROL METHOD, CONTROL DEVICE, AND VEHICLE

(71) Applicant: HONDA MOTOR CO., LTD., Tokyo (JP)

(72) Inventor: Toru OGAKI, Tokyo (JP)

(73) Assignee: HONDA MOTOR CO., LTD., Tokyo (JP)

(21) Appl. No.: 18/591,841

(22) Filed: Feb. 29, 2024

(30) Foreign Application Priority Data
Mar. 22, 2023 (JP) 2023-045438

(51) Int. Cl. H01M 10/63; H01M 10/613; H01M 10/615; H01M 10/625

(52) U.S. Cl. CPC H01M 10/63; H01M 10/613; H01M 10/615; H01M 10/625; H01M 2220/20

(57) ABSTRACT

A control method of a vehicle includes, in response to an execution condition of a temperature adjustment control and a power consuming control being satisfied, deriving, by a computer, a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of a cooling device, and a second efficiency which is a heating amount per unit power of a heating device; and executing, by the computer, the temperature adjustment control and the power consuming control by causing the cooling device to perform cooling and the heating device to perform heating based on the derived cooling amount and the derived heating amount.

This application is based upon and claims the benefit of priority from prior Japanese patent application No. 2023-45438, filed on Mar. 22, 2023, the entire contents of which are incorporated herein by reference.

### TECHNICAL FIELD

The present disclosure relates to a control method, a control device, and a vehicle.

### BACKGROUND ART

In recent years, as a specific countermeasure against global climate change, efforts for realizing a low-carbon society or a decarbonized society have become active. Reduction in CO₂ emissions and an improvement in energy efficiency in a vehicle such as an automobile are also required, and electrification of its drive source is progressing. For example, a vehicle (for example, an electric automobile or a hybrid electric automobile) including a motor (also referred to as a “traction motor”) as a drive source that drives drive wheels, and a battery as a power supply that supplies power to the motor is developed.

Some vehicles have a traction motor functioning as an electrical generator during braking, and a battery configured to be charged with the generated power. Some vehicles among such vehicles are configured such that a regeneration amount of a traction motor is limited to protect a battery from overcharging when a remaining capacity of the battery exceeds a predetermined value.

In a case where the regeneration amount of the traction motor is limited, a regenerative braking force becomes weaker than usual, which may give a driver a sense of discomfort due to a change in a brake feeling. On the other hand, elimination of limitation on the regeneration amount to prioritize the prevention of the change in the brake feeling may cause deterioration of the battery due to overcharging. JP2019-119291A discloses a technique in which, when it is determined regenerative braking (regenerative power generation) is performed by an electric motor in a state in which a remaining capacity of a power storage device is equal to or greater than a predetermined value, an operation (power consuming operation) of an air conditioner for actively consuming power of the power storage device is executed.

### SUMMARY

It is desirable to adjust a temperature of a battery within an appropriate temperature range from the viewpoint of ensuring output performance and preventing deterioration. In the related art, there is room for improvement from the viewpoint of achieving both temperature adjustment of the battery and power consumption to actively consume power of the battery.

Aspects of the present disclosure relate to providing a control method, a control device, and a vehicle capable of consuming desired power from a battery while appropriately adjusting a temperature of the battery.

According to an aspect of the present disclosure, there is provided 1a control method of a vehicle, the vehicle including a battery, a cooling device configured to cool the battery using power of the battery, and a heating device configured to heat the battery using power of the battery, the control method executed by a computer, to control the vehicle, configured to execute temperature adjustment control for performing at least one of cooling by the cooling device and heating by the heating device so as to maintain the battery in a predetermined temperature range based on a temperature of the battery, and to execute power consuming control for performing cooling by the cooling device and heating by the heating device so as to consume a prescribed amount of power according to a remaining capacity of the battery, the control method including:
in response to an execution condition of the temperature adjustment control and the power consuming control being satisfied, deriving a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device; and
executing the temperature adjustment control and the power consuming control by causing the cooling device to perform cooling and the heating device to perform heating based on the derived cooling amount and the derived heating amount.

According to another aspect of the present disclosure, there is provided a control device for controlling a vehicle, the vehicle including a battery, a cooling device configured to cool the battery using power of the battery, and a heating device configured to heat the battery using power of the battery, in which
the control device is configured to
   execute temperature adjustment control for performing at least one of cooling by the cooling device and heating by the heating device so as to maintain the battery in a predetermined temperature range based on a temperature of the battery, and
   execute power consuming control for performing cooling by the cooling device and heating by the heating device so as to consume a prescribed amount of power according to a remaining capacity of the battery, and,
in response to an execution condition of the temperature adjustment control and the power consuming control being satisfied, the control device is configured to
   derive a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device, and
   execute the temperature adjustment control and the power consuming control by causing the cooling device to perform cooling and the heating device to perform heating based on the derived cooling amount and the derived heating amount.

According to another aspect of the present disclosure, there is provided a vehicle, including:
a battery;
a cooling device configured to cool the battery using power of the battery;
a heating device configured to heat the battery using power of the battery; and
a control device configured to
   execute temperature adjustment control for performing at least one of cooling by the cooling device and heating by the heating device so as to maintain the battery in a predetermined temperature range based on a temperature of the battery, and
   execute power consuming control for performing cooling by the cooling device and heating by the heating device so as to consume a prescribed amount of power according to a remaining capacity of the battery, in which,
in response to an execution condition of the temperature adjustment control and the power consuming control being satisfied, the control device is configured to
   derive a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device, and
   execute the temperature adjustment control and the power consuming control by causing the cooling device to perform cooling and the heating device to perform heating based on the derived cooling amount and the derived heating amount.

According to aspects of the present disclosures, it is possible to provide a control method, a control device, and a vehicle capable of consuming desired power from a battery while appropriately adjusting a temperature of the battery.

### BRIEF DESCRIPTION OF DRAWINGS

Exemplary embodiment(s) of the present invention will be described in detail based on the following figures, wherein:

FIG. 1 shows a vehicle 10 equipped with a battery 11 whose temperature is to be adjusted;

FIG. 2 shows an example of a temperature adjustment device 15 that adjusts a temperature of the battery 11;

FIG. 3 is a flowchart (part 1) showing an example of processing executed by a control device 17 of the vehicle 10; and

FIG. 4 is a flowchart (part 2) showing the example of the processing executed by the control device 17 of the vehicle 10.

### DESCRIPTION OF EMBODIMENTS

Hereinafter, an embodiment of a control method, a control device, and a vehicle according to the present disclosure will be described in detail with reference to the drawings. The drawings are viewed in directions of reference numerals. The following embodiment does not limit the disclosure described in the scope of claims, and not all combinations of features described in the embodiment are essential to the disclosure. Two or more of features among a plurality of features described in the embodiment may be combined freely. In addition, in the following description, the same or similar elements are denoted by the same or similar reference numerals, and the description thereof may be omitted or simplified as appropriate.

### (Vehicle)

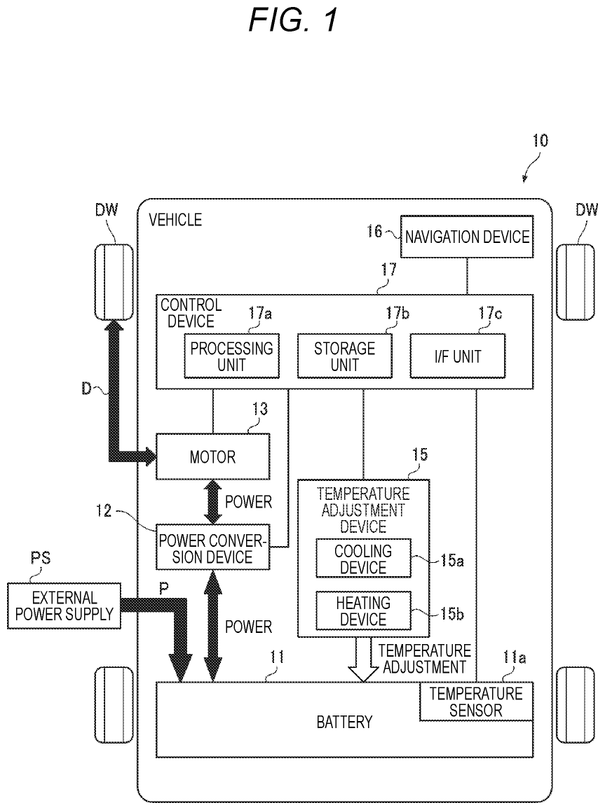

First, an example of a vehicle equipped with a battery whose temperature is to be adjusted (temperature adjusted) by a control method according to the present disclosure will be described. As shown in FIG. 1, a vehicle 10 according to the present embodiment is an electric automobile including a battery 11 that is a chargeable and dischargeable secondary battery, a motor 13 configured to drive drive wheels DW by being supplied with power from the battery 11, and a power conversion device 12 that converts power transferred between the battery 11 and the motor 13.

The battery 11 is configured to be charged with power P received from an external power supply PS, for example. The external power supply PS is, for example, a commercial power supply that supplies alternating current having a predetermined voltage (for example, 100 [V] to 200 [V]) and a predetermined frequency (for example, 50 [Hz] to 60 [Hz]).

Specifically, the vehicle 10 is configured to be electrically connectable to the external power supply PS. Electrical connection between the vehicle 10 and the external power supply PS may be established by a physical connector, a cable, or the like, or may be established by wireless power transfer. In a case where the wireless power transfer is adopted, a method of power transfer may be an electromagnetic induction type, a magnetic resonance type, a combination of the electromagnetic induction type and the magnetic resonance type, or the like.

The power P received from the external power supply PS is converted from alternating current (AC) to direct current (DC) by a charger (not shown) included in the vehicle 10, is converted to a voltage suitable for charging the battery 11, and then is supplied to the battery 11. Accordingly, the vehicle 10 may charge the battery 11 with the power P received from the external power supply PS.

The battery 11 is configured to output a high voltage (for example, 100 [V] to 400 [V]) with a plurality of storage cells connected to each other in series, and is connected to the motor 13 via the power conversion device 12. A lithium-ion battery, a nickel-metal hydride battery, or the like may be used as the storage cell of the battery 11. The battery 11 is provided with, for example, a temperature sensor 11a that detects a current temperature of the battery 11 (hereinafter also referred to as a “battery temperature”), and a detection signal indicating the battery temperature detected by the temperature sensor 11a is sent to a control device 17 to be described later. Accordingly, the control device 17 may acquire the battery temperature detected by the temperature sensor 11a.

The power conversion device 12 includes an inverter, converts direct current output from the battery 11 into alternating current, and supplies the converted alternating current to the motor 13 implemented by an alternating current motor (for example, a three-phase alternating current motor). The power conversion device 12 may further include, for example, a DC/DC converter, and convert a voltage of the power transferred between the battery 11 and the motor 13.

The motor 13 is connected to the drive wheels DW via a power transmission device (not shown) included in the vehicle 10, and outputs, to the drive wheels DW, a driving force (driving force for traveling) D for driving the vehicle 10 by being supplied with power. Therefore, the vehicle 10 may travel with the driving force output by the motor 13 by supplying the power of the battery 11 to the motor 13. That is, the motor 13 is a so-called “traction motor”.

The motor 13 may also perform regenerative power generation in braking of the vehicle 10 and output the generated power (alternating current) to the power conversion device 12. In this case, the power conversion device 12 converts alternating current output from the motor 13 into direct current and supplies the converted direct current to the battery 11. Accordingly, the vehicle 10 may also charge the battery 11 with the power generated by the motor 13 in braking of the vehicle 10.

The vehicle 10 further includes a temperature adjustment device 15 configured to adjust a temperature of the battery 11, a navigation device 16 that navigates the traveling of the vehicle 10, and a control device 17 that comprehensively controls the entire vehicle 10.

The temperature adjustment device 15 performs the temperature adjustment on the battery 11 under the control of the control device 17. In the present embodiment, the temperature adjustment device 15 includes a cooling device 15a as a chiller capable of cooling the battery 11 and a heating device 15b as a heater capable of heating the battery 11, and is configured to perform cooling and heating of the battery 11 as the temperature adjustment of the battery 11.

The navigation device 16 includes, for example, a global navigation satellite system (GNSS) receiver capable of specifying a current position of the vehicle 10, and determines, with reference to map data or the like stored in advance, a route (hereinafter, also referred to as a “guidance route”) from the current position specified by the GNSS receiver to a destination set by a user (for example, a driver) of the vehicle 10. At this time, for example, when it is predicted that a remaining capacity (hereinafter, also referred to as “state of charge (SOC)”) of the battery 11 is equal to or smaller than a predetermined value on the way to the destination, the navigation device 16 determines a guidance route including, as a via-point, charging equipment (for example, a so-called charging station) capable of charging the battery 11.

When the navigation device 16 determines the guidance route, the navigation device 16 displays the determined guidance route on a display (not shown) of the vehicle 10 or the like to provide guidance to the user. Accordingly, the vehicle 10 may travel along the guidance route. That is, the guidance route is a route along which the vehicle 10 is scheduled to travel (hereinafter, also referred to as a “scheduled travel route”). The navigation device 16 may output information indicating the determined guidance route, that is, the scheduled travel route, to the control device 17 to be described later.

The control device 17 is a computer that comprehensively controls the entire vehicle 10 including the power conversion device 12, the motor 13, and the temperature adjustment device 15, and is an example of the control device according to the present disclosure. The control device 17 is implemented by, for example, an electric control unit (ECU). The control device 17 may be implemented by one ECU, or may be implemented by a cooperation of a plurality of ECUs.

The control device 17 includes a processing unit 17a, a storage unit 17b such as a random access memory (RAM) and a read only memory (ROM), and an I/F unit 17c (interface unit) that controls input and output of data between the inside and the outside of the control device 17.

The processing unit 17a is a processor such as a central processing unit (CPU), and executes a program stored in the storage unit 17b. The storage unit 17b stores the program executed by the processing unit 17a as well as data used for processing by the processing unit 17a. For example, the control device 17 executes various controls by the processing unit 17a executing programs stored in the storage unit 17b. Since details of the control executed by the control device 17 will be described later, the description thereof will be omitted here.

### (Example of Temperature Adjustment Device)

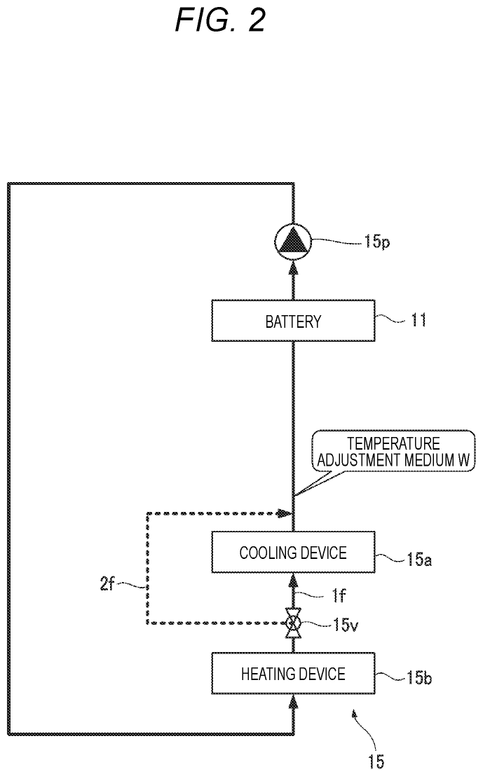

As shown in FIG. 2, the temperature adjustment device 15 adjusts a temperature of the battery 11 by circulating a temperature adjustment medium W realized by cooling water such as a long life coolant (LLC). In the example shown in FIG. 2, the cooling device 15a and the heating device 15b are provided upstream of the battery 11 and a pump 15p is provided downstream of the battery 11 in a circulation path (arrow indicated by a thick solid line in FIG. 2) of the temperature adjustment medium W. The pump 15p is an electric pump that pumps the temperature adjustment medium W, and is controlled by the control device 17.

The cooling device 15a includes, for example, a radiator (not shown), and may cool the temperature adjustment medium W by heat exchange with the outside air via the radiator. Further, the heating device 15b includes, for example, an electric heater (not shown), and may control heating of the temperature adjustment medium W by controlling power supply to the electric heater.

As an example, in the present embodiment, a flow path switching valve 15v realized by a three-way valve or the like is provided between the cooling device 15a and the heating device 15b. The flow path switching valve 15v is configured to switch a flow path of the temperature adjustment medium W from the heating device 15b between a first flow path 1f that guides the temperature adjustment medium W to the cooling device 15a as indicated by a solid arrow and a second flow path 2f that bypasses the cooling device 15a as indicated by a broken arrow.

In a case where the flow path of the temperature adjustment medium W from the heating device 15b is the first flow path 1f, the temperature adjustment medium W is cooled by the cooling device 15a and supplied to the battery 11. On the other hand, in the case of the second flow path 2f, since the temperature adjustment medium W from the heating device 15b bypasses the cooling device 15a, the temperature adjustment medium W is supplied to the battery 11 without being cooled. The flow path switching valve 15v is configured as, for example, an electrically controllable solenoid valve, and is controlled by the control device 17.

For cooling the battery 11 in the temperature adjustment of the battery 11 by the temperature adjustment device 15, the control device 17 may operate the cooling device 15a while not supplying power to the electric heater of the heating device 15b, and control the flow path switching valve 15v such that the flow path of the temperature adjustment medium W from the heating device 15b becomes the first flow path 1f. For heating the battery 11 in the temperature adjustment of the battery 11 by the temperature adjustment device 15, the control device 17 may control the flow path switching valve 15v such that the flow path of the temperature adjustment medium W from the heating device 15b becomes the second flow path 2f after supplying power to the electric heater of the heating device 15b. The configuration of the temperature adjustment device 15 described here is merely an example, and the present disclosure is not limited thereto. The specific configuration of the temperature adjustment device 15 is not particularly limited as long as the temperature adjustment device 15 may cool and heat the battery 11 under the control of the control device 17.

### (Control Device)

Based on the battery temperature, the control device 17 executes temperature adjustment control for performing cooling by the cooling device 15a and/or heating by the heating device 15b so as to maintain the battery 11 in a predetermined temperature range (hereinafter also referred to as a “target temperature range”). More specifically, the control device 17 executes the temperature adjustment control, for example, based on the battery temperature becoming a temperature outside the target temperature range (that is, a temperature higher than an upper limit temperature of the target temperature range or a temperature lower than a lower limit temperature of the target temperature range). That is, an execution condition of the temperature adjustment control is, for example, that the battery temperature becomes a temperature outside the target temperature range. In this way, the control device 17 appropriately executes the temperature adjustment control based on the battery temperature, and thus it is possible to prevent the temperature of the battery 11 from becoming extremely high or low with respect to the target temperature range, and to ensure the output performance of the battery 11 or prevent deterioration.

Further, the control device 17 executes power consuming control for performing cooling by the cooling device 15a and heating by the heating device 15b so as to consume a prescribed amount of power according to the remaining capacity (that is, SOC) of the battery 11. More specifically, the control device 17 executes the power consuming control, for example, based on the SOC of the battery 11 exceeding a predetermined threshold value (for example, 90 [%]). That is, an execution condition of the power consuming control is, for example, that the SOC of the battery 11 exceeds a predetermined threshold value. In this way, the control device 17 appropriately executes the power consuming control based on the SOC of the battery 11, and thus the battery 11 may be kept in a state where the battery 11 can appropriately receive the power generated by the motor 13 during braking of the vehicle 10. Accordingly, it is possible to cause the motor 13 to perform regenerative power generation during braking of the vehicle 10 and charge the battery 11 with the power generated by the regenerative power generation, and it is possible to brake the vehicle 10 with a braking force generated by the regenerative power generation.

Meanwhile, it is also conceivable that the execution conditions of the temperature adjustment control and the power consuming control are satisfied at the same time. In a case where the execution conditions of the temperature adjustment control and the power consuming control are satisfied as described above, if the temperature adjustment control is prioritized and executed and the power consuming control is not executed, the SOC of the battery 11 may become too high. On the other hand, in the case where the execution conditions of the temperature adjustment control and the power consuming control are satisfied, if the power consuming control is prioritized and executed and the temperature adjustment control is not executed, the battery temperature may not be maintained within an appropriate temperature range. Therefore, in the case where both the execution conditions of the temperature adjustment control and the power consuming control are satisfied, it is desirable to achieve both the temperature adjustment control and the power consuming control.

In the case where the execution conditions of the temperature adjustment control and the power consuming control are satisfied, the control device 17 derives a cooling amount Q_{Chiller} of the cooling device 15a and a heating amount Q_{ECH} of the heating device 15b based on a target temperature adjustment amount Q_{R} which is a target value of the temperature adjustment control, a target power consumption amount E_{R} which is a target value of the power consuming control, a first efficiency η_{chiller} which is a cooling amount per unit power of the cooling device 15a, and a second efficiency η_{ECH} which is a heating amount per unit power of the heating device 15b. Based on the derived cooling amount Q_{Chiller} and the derived heating amount Q_{ECH}, the control device 17 executes the temperature adjustment control and the power consuming control by causing the cooling device 15a to perform cooling and the heating device 15b to perform heating. Accordingly, it is possible to perform temperature adjustment of the target temperature adjustment amount Q_{R} by cooling performed by the cooling device 15a and heating performed by the heating device 15b, and it is possible to consume power corresponding to the target power consumption amount E_{R} by the temperature adjustment. Therefore, both the temperature adjustment control and the power consuming control may be performed, and desired power may be consumed from the battery 11 while appropriately adjusting the temperature of the battery 11.

More specifically, the target temperature adjustment amount Q_{R} which is the target value of the temperature adjustment control may be expressed by, for example, the following formula (1) using the cooling amount Q_{Chiller} and the heating amount Q_{ECH} in the temperature adjustment control.

$$\begin{matrix}( Formula 1 ) & \\ {Q}_{ECH} + {Q}_{Chiller} = {Q}_{R} & ( 1 )\end{matrix}$$

The target power consumption amount E_{R} which is the target value of the power consuming control can be expressed by, for example, the following formula (2) using the first efficiency η_{chiller} of the cooling device 15a, the second efficiency η_{ECH} of the heating device 15b, the cooling amount Q_{Chiller}, and the heating amount Q_{ECH}.

$$\begin{matrix}( Formula 2 ) & \\ \frac{{Q}_{ECH}}{{η}_{ECH}} - \frac{{Q}_{Chiller}}{{η}_{Chiller}} = {E}_{R} & ( 2 )\end{matrix}$$

From the formulas (1) and (2), the cooling amount Q_{Chiller} may be expressed by, for example, the following formula (3). The heating amount Q_{ECH} may be expressed by, for example, the following formula (4).

$$\begin{matrix}( Formula 3 ) & \\ {Q}_{Chiller} = \frac{{η}_{Chiller} \cdot {Q}_{R} - {η}_{ECH} \cdot {η}_{Chiller} \cdot {E}_{R}}{{η}_{ECH} + {η}_{Chiller}} & ( 3 )\end{matrix}$$

$$\begin{matrix}( Formula 4 ) & \\ {Q}_{ECH} = \frac{{η}_{ECH} \cdot {η}_{Chiller} \cdot {E}_{R} + {η}_{ECH} \cdot {Q}_{R}}{{η}_{ECH} + {η}_{Chiller}} & ( 4 )\end{matrix}$$

In the case where the execution conditions of the temperature adjustment control and the power consuming control are satisfied, the control device 17 derives the cooling amount Q_{Chiller} using the formula (3) and derives the heating amount Q_{ECH} using the formula (4), for example. Accordingly, the control device 17 may acquire the cooling amount Q_{Chiller} and the heating amount Q_{ECH} such that the power consumption due to the temperature adjustment of the battery 11 performed by the temperature adjustment control becomes the target power consumption amount E_{R} of the power consuming control. Therefore, both the temperature adjustment control and the power consuming control may be achieved.

When the cooling amount Q_{Chiller} and the heating amount Q_{ECH} are derived, for example, a value, which is derived based on a current battery temperature, input and output power of the battery 11, or the like from a map (information), a calculation formula, or the like prepared in advance, is used as the target temperature adjustment amount Q_{R}. As the target power consumption amount E_{R}, for example, a value, which is derived based on a current SOC of the battery, input and output power of the battery 11, or the like from a map, a calculation formula, or the like prepared in advance, is used. As the first efficiency η_{chiller} of the cooling device 15a and the second efficiency η_{ECH} of the heating device 15b, for example, values set in advance by a manufacturer of the vehicle 10 are used.

### (Example of Processing Executed by Control Device)

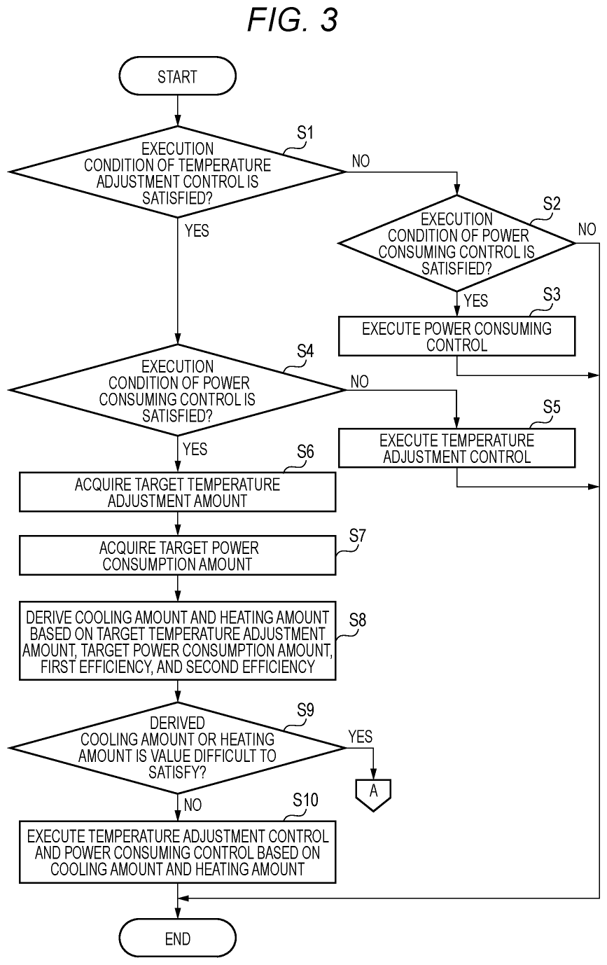

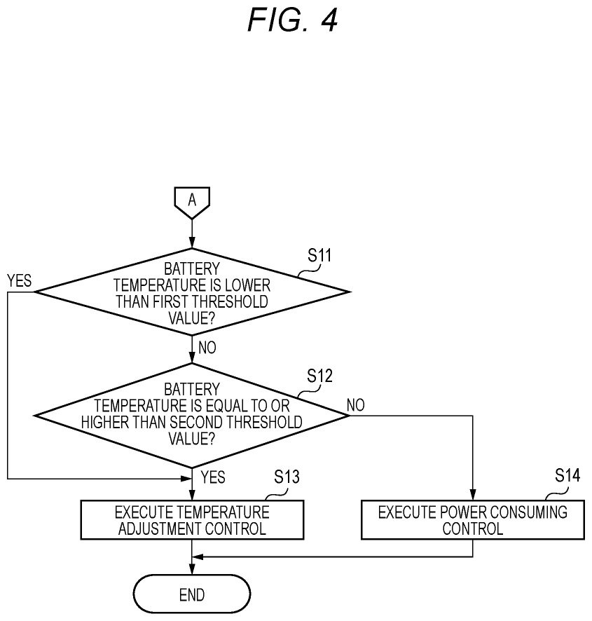

Next, an example of processing executed by the control device 17 will be described with reference to FIGS. 3 and 4. For example, when an ignition power supply of the vehicle 10 is turned on, the control device 17 repeatedly executes a series of processing shown in FIGS. 3 and 4 at a predetermined cycle.

First, the control device 17 determines whether the execution condition of the temperature adjustment control is satisfied (step S1). In a case where it is determined that the execution condition of the temperature adjustment control is not satisfied (step S1: NO), the control device 17 determines whether the execution condition of the power consuming control is satisfied (step S2). If it is determined that the execution condition of the power consuming control is not satisfied (step S2: NO), the control device 17 ends the series of processing shown in FIGS. 3 and 4.

On the other hand, in a case where it is determined that the execution condition of the power consuming control is satisfied (step S2: YES), the control device 17 executes the power consuming control (step S3) and ends the series of processing shown in FIGS. 3 and 4. In the processing of step S3, for example, the control device 17 executes the power consuming control for performing cooling by the cooling device 15a and heating by the heating device 15b such that the target temperature adjustment amount Q_{R} is set to 0 and the cooling amount Q_{Chiller} of the cooling device 15a is equal to the heating amount Q_{ECH} of the heating device 15b (that is, Q_{Chiller}=Q_{ECH}). Accordingly, it is possible to execute power consuming control for consuming the power of the target power consumption amount E_{R} while maintaining the current battery temperature.

In the processing of step S1, in a case where it is determined that the execution condition of the temperature adjustment control is satisfied (step S1: YES), the control device 17 determines whether the execution condition of the power consuming control is satisfied (step S4). In a case where it is determined that the execution condition of the power consuming control is not satisfied (step S4: NO), the control device 17 executes the temperature adjustment control (step S5) and ends the series of processing shown in FIGS. 3 and 4. In the processing of step S5, for example, the control device 17 executes normal temperature adjustment control in which only the heating device 15b is operated when the target temperature adjustment amount Q_{R} becomes a positive value (that is, when heating is performed) based on the battery temperature becoming a temperature lower than the lower limit temperature of the target temperature range, and conversely, only the cooling device 15a is operated when the target temperature adjustment amount Q_{R} becomes a negative value (that is, when cooling is performed) based on the battery temperature becoming a temperature higher than the upper limit temperature of the target temperature range.

On the other hand, in the processing of step S4, in a case where it is determined that the execution condition of the power consuming control is satisfied (step S4: YES), the control device 17 acquires the target temperature adjustment amount Q_{R} (step S6), and further acquires the target power consumption amount E_{R} (step S7).

The control device 17 derives the cooling amount Q_{Chiller} and the heating amount Q_{ECH} based on the target temperature adjustment amount Q_{R}, the target power consumption amount E_{R}, the first efficiency η_{chiller} of the cooling device 15a, and the second efficiency η_{ECH} of the heating device 15b (step S8). In the processing of step S8, as described above, the control device 17 derives the cooling amount Q_{Chiller} using the formula (3) and derives the heating amount Q_{ECH} using the formula (4), for example.

Next, the control device 17 determines whether the derived cooling amount Q_{Chiller} or heating amount Q_{ECH} is a value difficult to satisfy (step S9). In the processing of step S9, for example, in a case where the cooling amount Q_{Chiller} that needs to be a negative value becomes a positive value, or the heating amount Q_{ECH} that needs to be a positive value becomes a negative value, the control device 17 determines that the cooling amount Q_{Chiller} or the heating amount Q_{ECH} is a value difficult to satisfy. On the other hand, in a case where the cooling amount Q_{Chiller} is a negative value and the heating amount Q_{ECH} is a positive value, the control device 17 determines that the cooling amount Q_{Chiller} or the heating amount Q_{ECH} is not a value difficult to satisfy (in other words, a value that can be satisfied). The condition for determining that the cooling amount Q_{Chiller} or the heating amount Q_{ECH} is a value difficult to satisfy is not limited to the example described here, and may be appropriately determined by the manufacturer of the vehicle 10 in consideration of hardware specifications of the cooling device 15a and the heating device 15b.

If it is determined that the cooling amount Q_{Chiller} and the heating amount Q_{ECH} are not values difficult to satisfy (step S9: NO), the control device 17 executes the temperature adjustment control and the power consuming control based on the derived cooling amount Q_{Chiller} and the derived heating amount Q_{ECH} (step S10), and ends the series of processing shown in FIGS. 3 and 4. In the processing of step S10, the control device 17 executes the temperature adjustment control and the power consuming control by performing cooling by the cooling device 15a and heating by the heating device 15b so that the cooling performed by the cooling device 15a corresponds to the cooling amount Q_{Chiller} and the heating performed by the heating device 15b corresponds to the heating amount Q_{ECH}.

On the other hand, in a case where it is determined that the derived cooling amount Q_{Chiller} and the derived heating amount Q_{ECH} are values difficult to satisfy (step S9: YES), the control device 17 proceeds to the processing of step S11 shown in FIG. 4 and determines whether the battery temperature is lower than a first threshold value (step S11). Here, the first threshold value is, for example, a value smaller than the lower limit value of the target temperature range described above, and is a threshold value set in advance by the manufacturer of the vehicle 10.

If it is determined that the battery temperature is not lower than the first threshold value (step S11: NO), the control device 17 determines whether the battery temperature is equal to or higher than a second threshold value (step S12). Here, the second threshold value is, for example, a value larger than the upper limit value of the target temperature range described above, and is a threshold value set in advance by the manufacturer of the vehicle 10.

In a case where it is determined that the battery temperature is lower than the first threshold value (step S11: YES) or in a case where it is determined that the battery temperature is equal to or higher than the second threshold value (step S12: YES), the control device 17 executes the temperature adjustment control (step S13) and ends the series of processing shown in FIGS. 3 and 4. In the processing of step S13, similarly to the processing of step S5, for example, the control device 17 executes normal temperature adjustment control in which only the heating device 15b is operated when the target temperature adjustment amount Q_{R} is a positive value, and only the cooling device 15a is operated when the target temperature adjustment amount Q_{R} is a negative value.

On the other hand, in a case where it is determined that the battery temperature is not equal to or higher than the second threshold value (step S12: NO), the control device 17 executes the power consuming control (step S14) and ends the series of processing shown in FIGS. 3 and 4. In the processing of step S3, similarly to the processing of step S14, for example, the control device 17 executes the power consuming control for performing cooling by the cooling device 15a and heating by the heating device 15b such that the target temperature adjustment amount Q_{R} is set to 0 and the cooling amount Q_{Chiller} of the cooling device 15a is equal to the heating amount Q_{ECH} of the heating device 15b.

As described above, in a case where the execution conditions of the temperature adjustment control and the power consuming control are satisfied, the control device 17 performs the following processing: deriving the cooling amount Q_{Chiller} of the cooling device 15a and the heating amount Q_{ECH} of the heating device 15b based on the target temperature adjustment amount Q_{R} which is the target value of the temperature adjustment control, the target power consumption amount E_{R} which is the target value of the power consuming control, the first efficiency η_{chiller} which is the cooling amount per unit power of the cooling device 15a, and the second efficiency η_{ECH} which is the heating amount per unit power of the heating device 15b; and executing the temperature adjustment control and the power consuming control by performing cooling by the cooling device 15a and heating by the heating device 15b based on the derived cooling amount Q_{Chiller} and the derived heating amount Q_{ECH}. Accordingly, it is possible to perform temperature adjustment of the target temperature adjustment amount Q_{R} by cooling performed by the cooling device 15a and heating performed by the heating device 15b, and it is possible to consume power corresponding to the target power consumption amount E_{R} by the temperature adjustment. Therefore, the desired power may be consumed from the battery 11 while appropriately adjusting the temperature of the battery 11.

In the processing of deriving the cooling amount Q_{Chiller} and the heating amount Q_{ECH} in the case where the execution conditions of the temperature adjustment control and the power consuming control are satisfied, the control device 17 derives the cooling amount Q_{Chiller} and the heating amount Q_{ECH} such that a sum of the cooling amount Q_{Chiller} and the heating amount Q_{ECH} becomes the target temperature adjustment amount Q_{R} and a sum of a power consumption amount (that is, Q_{Chiller}/η_{Chiller}) of the cooling device 15a and a power consumption amount (that is, Q_{ECH}/η_{Chiller}) of the heating device 15b becomes the target power consumption amount E_{R}. Accordingly, it is possible to perform temperature adjustment of the target temperature adjustment amount Q_{R} by cooling performed by the cooling device 15a and heating performed by the heating device 15b, and it is possible to consume power corresponding to the target power consumption amount E_{R} by the temperature adjustment.

The control device 17 further performs processing of executing any one of the temperature adjustment control and the power consuming control in a case where at least one of the cooling amount Q_{Chiller} and the heating amount Q_{ECH} is a value difficult to satisfy, which are derived by the processing of deriving the cooling amount Q_{Chiller} and the heating amount Q_{ECH} when the execution conditions of the temperature adjustment control and the power consuming control are satisfied. Accordingly, in a case where it is difficult to achieve both the temperature adjustment control and the power consuming control, any one of the temperature adjustment control and the power consuming control is executed, and thus it is possible to appropriately adjust the temperature of the battery 11 or to consume the desired power from the battery 11.

In the processing of executing any one of the temperature adjustment control and the power consuming control, the control device 17 executes only the temperature adjustment control of the temperature adjustment control and the power consuming control in a case where the battery temperature is lower than the first threshold value that is smaller than the lower limit value of the target temperature range, or the battery temperature is equal to or higher than the second threshold value that is larger than the upper limit value of the target temperature range. Accordingly, in a case where the temperature of the battery 11 is extremely high or low with respect to the target temperature range, the temperature adjustment control may be executed. Accordingly, by appropriately adjusting the temperature of the battery 11, it is possible to ensure the output performance of the battery 11 and prevent deterioration.

In the processing of executing any one of the temperature adjustment control and the power consuming control, the control device 17 executes only the power consuming control, among the temperature adjustment control and the power consuming control, in a case where the battery temperature is equal to or higher than the first threshold value and lower than the second threshold value. Accordingly, in a case where the temperature of the battery 11 is not extremely high or low with respect to the target temperature range, the power consuming control may be executed. Accordingly, it is possible to reduce the remaining capacity of the battery 11 by consuming the desired power from the battery 11.

Although an embodiment of the present disclosure has been described above with reference to the accompanying drawings, it is needless to say that the present disclosure is not limited to the embodiment described above. It is apparent that those skilled in the art may conceive of various modifications and changes within the scope described in the claims, and it is understood that such modifications and changes naturally fall within the technical scope of the present disclosure. In addition, the respective constituent elements in the above embodiment may be combined as desired without departing from the gist of the disclosure.

In the embodiment described above, an example in which the control device according to the present disclosure is implemented by the control device 17 mounted in the vehicle 10 is described, but the present disclosure is not limited thereto. For example, the control device according to the present disclosure may be implemented by a server that is communicatable with the control device 17. In this case, for example, the processing of the control device 17 described above may be performed by a processing unit implemented by a CPU of the server or the like. The control device according to the present disclosure may be implemented by cooperation between the control device 17 and the server, and for example, part of the processing of the control device 17 described above may be executed by the server.

The control method described in the embodiment described above may be implemented by executing a program prepared in advance on a computer. The program (control program) is stored in a computer-readable storage medium and is executed by being read from the storage medium. In addition, the program may be provided in a form stored in a nonvolatile (non-transitory) storage medium such as a flash memory, or may be provided via a network such as Internet. The computer that executes the program may be included in the vehicle 10 or may be included in an external device (for example, a server) that is communicatable with the vehicle 10.

In the present specification, at least the following matters are described. Although corresponding constituent elements in the embodiment described above are shown in parentheses, the present disclosure is not limited thereto.
(1) A control method of a vehicle (vehicle 10), the vehicle including a battery (battery 11), a cooling device (cooling device 15a) configured to cool the battery using power of the battery, and a heating device (heating device 15b) configured to heat the battery using power of the battery, the control method executed by a computer (control device 17), to control the vehicle, configured to execute temperature adjustment control for performing at least one of cooling by the cooling device and heating by the heating device so as to maintain the battery in a predetermined temperature range based on a temperature of the battery, and to execute power consuming control for performing cooling by the cooling device and heating by the heating device so as to consume a prescribed amount of power according to a remaining capacity of the battery, the control method including:
in response to an execution condition of the temperature adjustment control and the power consuming control being satisfied, deriving a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device (step S8); and
executing the temperature adjustment control and the power consuming control by causing the cooling device to perform cooling and the heating device to perform heating based on the derived cooling amount and the derived heating amount (step S10).

According to (1), it is possible to perform temperature adjustment of the target temperature adjustment amount by cooling performed by the cooling device and heating performed by the heating device, and it is possible to consume power corresponding to the target power consumption amount by the temperature adjustment. Therefore, the desired power may be consumed from the battery while appropriately adjusting the temperature of the battery.
(2) The control method according to (1), in which,
the cooling amount and the heating amount are derived such that a sum of the cooling amount and the heating amount becomes the target temperature adjustment amount and a sum of a power consumption amount of the cooling device and a power consumption amount of the heating device becomes the target power consumption amount.

According to (2), it is possible to perform temperature adjustment of the target temperature adjustment amount by cooling performed by the cooling device and heating performed by the heating device, and it is possible to consume power corresponding to the target power consumption amount by the temperature adjustment.
(3) The control method according to (2), further including,
in response to at least one of the derived cooling amount and the derived heating amount being a value difficult to satisfy, executing one of the temperature adjustment control and the power consuming control (step S13, step S14).

According to (3), in a case where it is difficult to achieve both the temperature adjustment control and the power consuming control, any one of the temperature adjustment control and the power consuming control is executed, and thus it is possible to appropriately adjust the temperature of the battery or to consume the desired power from the battery.
(4) The control method according to (3), further including,
in response to a temperature of the battery being lower than a first threshold value or the temperature of the battery being equal to or higher than a second threshold value, executing only the temperature adjustment control (step S13), of the temperature adjustment control and the power consuming control, in which
the first threshold value is smaller than a lower limit value of the temperature range, and
the second threshold value is larger than an upper limit value of the temperature range.

According to (4), in a case where the temperature of the battery is extremely high or low, the temperature adjustment control may be executed. Accordingly, by appropriately adjusting the temperature of the battery, it is possible to ensure the output performance of the battery and prevent deterioration.
(5) The control method according to (4), further including,
in response to the temperature of the battery being equal to or higher than the first threshold value and lower than the second threshold value, executing only the power consuming control (step S14), of the temperature adjustment control and the power consuming control.

According to (5), in a case where the temperature of the battery is not extremely high or low, the power consuming control may be executed. Accordingly, it is possible to reduce the remaining capacity of the battery by consuming desired power from the battery.
(6) A control device (control device 17) for controlling a vehicle 10( ), the vehicle including a battery (battery 11), a cooling device (cooling device 15a) configured to cool the battery using power of the battery, and a heating device (heating device 15b) configured to heat the battery using power of the battery, in which
the control device is configured to
   execute temperature adjustment control for performing at least one of cooling by the cooling device and heating by the heating device so as to maintain the battery in a predetermined temperature range based on a temperature of the battery, and
   execute power consuming control for performing cooling by the cooling device and heating by the heating device so as to consume a prescribed amount of power according to a remaining capacity of the battery, and,
in response to an execution condition of the temperature adjustment control and the power consuming control being satisfied, the control device is configured to
   derive a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device, and
   execute the temperature adjustment control and the power consuming control by causing the cooling device to perform cooling and the heating device to perform heating based on the derived cooling amount and the derived heating amount.

According to (6), it is possible to perform temperature adjustment of the target temperature adjustment amount by cooling performed by the cooling device and heating performed by the heating device, and it is possible to consume power corresponding to the target power consumption amount by the temperature adjustment. Therefore, the desired power may be consumed from the battery while appropriately adjusting the temperature of the battery.
(7) A vehicle (vehicle 10) including:
a battery (battery 11);
a cooling device (cooling device 15a) configured to cool the battery using power of the battery;
a heating device (heating device 15b) configured to heat the battery using power of the battery; and
a control device (control device 17) configured to
   execute temperature adjustment control for performing at least one of cooling by the cooling device and heating by the heating device so as to maintain the battery in a predetermined temperature range based on a temperature of the battery, and
   execute power consuming control for performing cooling by the cooling device and heating by the heating device so as to consume a prescribed amount of power according to a remaining capacity of the battery, in which,
in response to an execution condition of the temperature adjustment control and the power consuming control being satisfied, the control device is configured to
   derive a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device, and
   execute the temperature adjustment control and the power consuming control by causing the cooling device to perform cooling and the heating device to perform heating based on the derived cooling amount and the derived heating amount.

According to (7), it is possible to perform temperature adjustment of the target temperature adjustment amount by cooling performed by the cooling device and heating performed by the heating device, and it is possible to consume power corresponding to the target power consumption amount by the temperature adjustment. Therefore, the desired power may be consumed from the battery while appropriately adjusting the temperature of the battery.

What is claimed is:

1. A control method of a vehicle, the vehicle including a battery, a cooling device configured to cool the battery using power of the battery, and a heating device configured to heat the battery using power of the battery, the control method executed by a computer, to control the vehicle, configured to execute temperature adjustment control for performing at least one of cooling by the cooling device and heating by the heating device so as to maintain the battery in a predetermined temperature range based on a temperature of the battery, and to execute power consuming control for performing cooling by the cooling device and heating by the heating device so as to consume a prescribed amount of power according to a remaining capacity of the battery, the control method comprising:
in response to an execution condition of the temperature adjustment control and the power consuming control being satisfied, deriving a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device; and
executing the temperature adjustment control and the power consuming control by causing the cooling device to perform cooling and the heating device to perform heating based on the derived cooling amount and the derived heating amount.

2. The control method according to claim 1, wherein,
the cooling amount and the heating amount are derived such that a sum of the cooling amount and the heating amount becomes the target temperature adjustment amount and a sum of a power consumption amount of the cooling device and a power consumption amount of the heating device becomes the target power consumption amount.

3. The control method according to claim 2, further comprising,
in response to at least one of the derived cooling amount and the derived heating amount being a value difficult to satisfy, executing one of the temperature adjustment control and the power consuming control.

4. The control method according to claim 3, further comprising,
in response to a temperature of the battery being lower than a first threshold value or the temperature of the battery being equal to or higher than a second threshold value, executing only the temperature adjustment control, of the temperature adjustment control and the power consuming control, wherein
the first threshold value is smaller than a lower limit value of the temperature range, and
the second threshold value is larger than an upper limit value of the temperature range.

5. The control method according to claim 4, further comprising,
in response to the temperature of the battery being equal to or higher than the first threshold value and lower than the second threshold value, executing only the power consuming control, of the temperature adjustment control and the power consuming control.

6. A control device for controlling a vehicle, the vehicle including a battery, a cooling device configured to cool the battery using power of the battery, and a heating device configured to heat the battery using power of the battery, wherein
the control device is configured to
execute temperature adjustment control for performing at least one of cooling by the cooling device and heating by the heating device so as to maintain the battery in a predetermined temperature range based on a temperature of the battery, and
execute power consuming control for performing cooling by the cooling device and heating by the heating device so as to consume a prescribed amount of power according to a remaining capacity of the battery, and,
in response to an execution condition of the temperature adjustment control and the power consuming control being satisfied, the control device is configured to
derive a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device, and
execute the temperature adjustment control and the power consuming control by causing the cooling device to perform cooling and the heating device to perform heating based on the derived cooling amount and the derived heating amount.

7. A vehicle, comprising:
a battery;
a cooling device configured to cool the battery using power of the battery;
a heating device configured to heat the battery using power of the battery; and
a control device configured to
execute temperature adjustment control for performing at least one of cooling by the cooling device and heating by the heating device so as to maintain the battery in a predetermined temperature range based on a temperature of the battery, and
execute power consuming control for performing cooling by the cooling device and heating by the heating device so as to consume a prescribed amount of power according to a remaining capacity of the battery, wherein,
in response to an execution condition of the temperature adjustment control and the power consuming control being satisfied, the control device is configured to
derive a cooling amount of the cooling device and a heating amount of the heating device based on a target temperature adjustment amount which is a target value of the temperature adjustment control, a target power consumption amount which is a target value of the power consuming control, a first efficiency which is a cooling amount per unit power of the cooling device, and a second efficiency which is a heating amount per unit power of the heating device, and
execute the temperature adjustment control and the power consuming control by causing the cooling device to perform cooling and the heating device to perform heating based on the derived cooling amount and the derived heating amount.
